(19) United States
(12) Patent Application Publication
(10) Pub. No.: US 2007/0030632 A1
(43) Pub. Date: Feb. 8, 2007

(54) MECHANISM FOR ADJUSTING A ROTARY ANGLE OF AN LCD

(75) Inventor: Tsung-Kan Cheng, Taipei (TW)

Correspondence Address: PAI PATENT & TRADEMARK LAW FIRM, 1001 FOURTH AVENUE, SUITE 3200, SEATTLE, WA, 98154, US

(73) Assignee: POSIFLEX INC., Taipei Hsien (TW)

(21) Appl. No.: 11/382,689

(22) Filed: May 10, 2006

(30) Foreign Application Priority Data
Aug. 8, 2005 (TW) 94213516

(51) Int. Cl. G06F 1/16

(52) U.S. Cl. 361/681

(57) ABSTRACT

A mechanism for adjusting a rotary angle of an LCD includes: a lower base with a sector rack and arcuate sliding grooves disposed at the top surface thereof; an upper base disposed with an LCD at an upper portion thereof, the bottom surface of the upper base being disposed with sliding posts for movably engaging with the arcuate sliding grooves; and a positioning mechanism including a positioning spring and a positioning push button. The positioning spring constantly urges the positioning push button to mate with one of the protruding teeth of the rack, thereby positioning the rotary angle of the upper base and the LCD. When the positioning push button is inwardly pushed, the positioning push button is disengaged from the protruding tooth thereby enabling the LCD to rotate right and left. The adjusting mechanism further includes an inhibiting mechanism for restricting the rotating scope of the LCD.

### RELATED APPLICATIONS

The present application is based on, and claims priority from, Taiwan Application Serial Number 94213516, filed Aug. 8, 2005, the disclosure of which is hereby incorporated by reference herein in its entirety.

### FIELD OF THE INVENTION

The present invention relates to a mechanism for adjusting angle, and particularly to a mechanism for adjusting a rotary angle of an LCD (liquid crystal display) which conveniently adjusts the right and left rotating angle of the LCD and steadily maintains the adjusted rotary angle.

### BACKGROUND OF THE INVENTION

A right and left rotary angle of an LCD needs to be adjusted to overcome its limited visual angle and to enable the LCD to be used as a touch panel.

A rotary angle of an LCD is conventionally adjusted and maintained by pivotal engagement between the bottom of the LCD and a base.

However, the manner of simply adjusting and positioning the angle through the pivot results in unstable angular position. When the LCD is employed as a touch panel, the force of a user's touch can sway or shift the LCD, which causes unstable operation and even causes the rotary angle to change, resulting in inconvenience and trouble in use.

### SUMMARY OF THE INVENTION

An object of the present invention is to provide a mechanism for adjusting a rotary angle of an LCD which can adjust and firmly maintain the right and left rotating angle of the LCD for enabling the LCD to maintain stability in operation.

In accordance with the above object, a mechanism for adjusting a rotary angle of an LCD of the present invention includes: a lower base with a sector rack disposed at the top surface thereof, the rack including a plurality of protruding teeth, at least two arcuate sliding grooves being defined in the top surface of the lower base and being in lateral symmetry; an upper base disposed with an LCD at an upper portion thereof, the bottom surface of the upper base being disposed with sliding posts corresponding to the position and number of the arcuate sliding grooves for movably engaging with the arcuate sliding grooves; and a positioning mechanism disposed at the bottom of the upper base corresponding to the rack. The positioning mechanism includes a positioning spring and a positioning push button defined with a cavity. The positioning spring constantly urges the cavity of the positioning push button to mate with one of the protruding teeth of the rack, thereby positioning the rotary angle of the upper base and the LCD. When the positioning push button is inwardly pushed, the cavity of the positioning push button is disengaged from the protruding tooth, thereby enabling the upper base and the LCD to right and left rotate.

Another object of the present invention is to provide a mechanism for adjusting a rotary angle of an LCD which can restrict the rotating scope of the LCD or release the restriction of the rotating scope of the LCD.

In accordance with the above object, the mechanism for adjusting a rotary angle of an LCD as described above further includes a protrusion disposed at the top surface of the lower base and an inhibiting mechanism disposed at the bottom surface of the upper base corresponding to the protrusion. The inhibiting mechanism includes an inhibiting spring and an inhibiting push button having a block. The inhibiting spring constantly urges the block of the inhibiting push button to outwardly move to abut against the protrusion thereby restricting rotation scope of the upper base and the LCD. When the inhibiting push button is inwardly pushed, the block is released from abutting against the protrusion thereby releasing the restriction of the rotation scope of the upper base and the LCD.

These and other embodiments, aspects and features of the invention will be better understood from a detailed description of the preferred embodiments of the invention, which are further described below in conjunction with the accompanying figures.

### BRIEF DESCRIPTION OF THE DRAWINGS

FIG. 1 is a perspective view of a mechanism for adjusting a rotary angle of an LCD of the present invention;

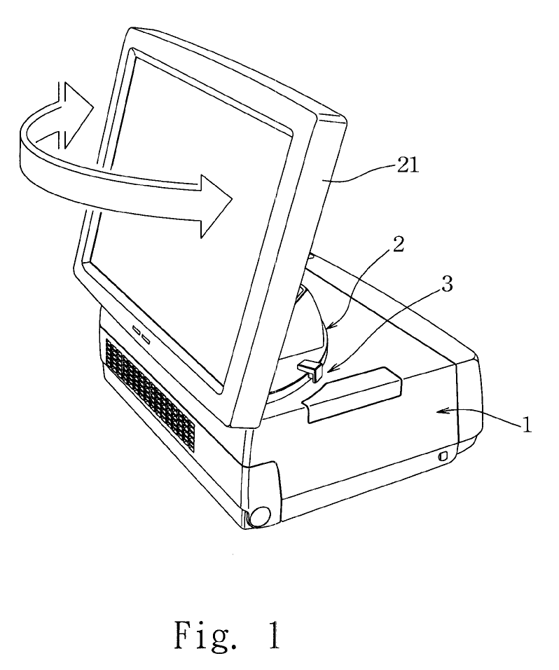

FIG. 2 is an exploded view of the adjusting mechanism of FIG. 1;

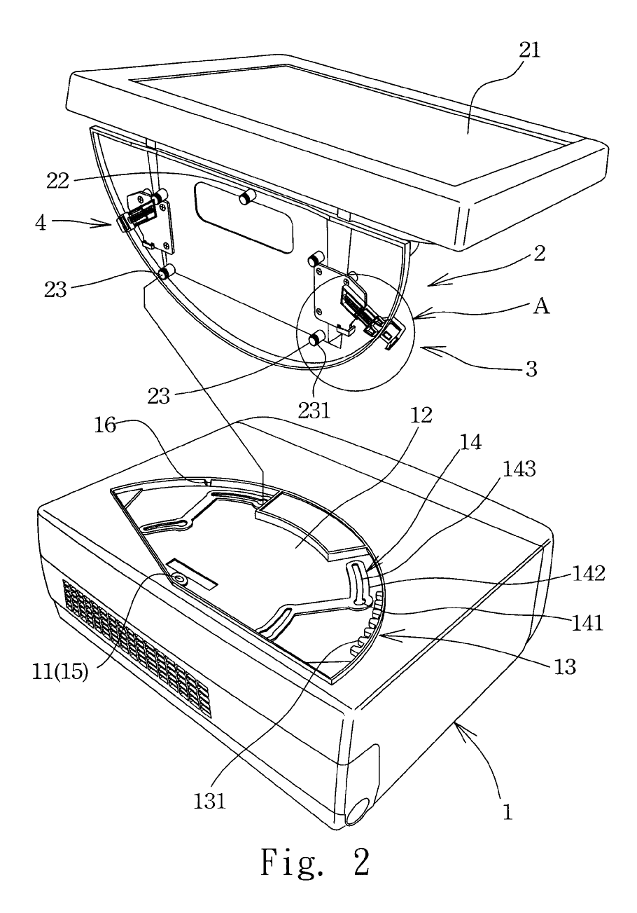

FIG. 3 is an enlarged view of circled portion A in FIG. 2;

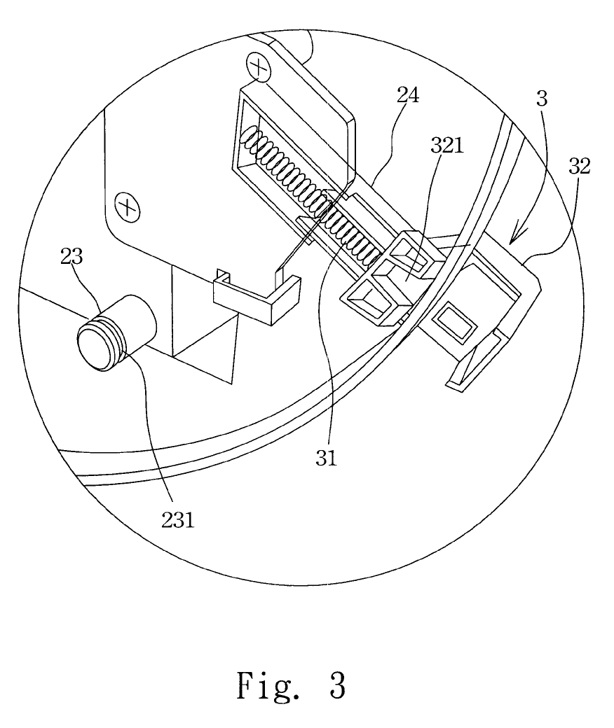

FIG. 4 is a top plan view of the adjusting mechanism of FIG. 1, showing operation of a positioning mechanism to enable the LCD to rotate right and left;

FIG. 5 is a top plan view of the adjusting mechanism of FIG. 1, showing operation of the positioning mechanism and an inhibiting mechanism to release the rotary angle of the LCD from restriction; and

FIG. 6 is a top plan view of the adjusting mechanism of FIG. 1, showing continuation of the operation of FIG. 5 to enable sliding posts to correspond to assembly holes of arcuate sliding grooves.

### DETAILED DESCRIPTION OF THE PREFERRED EMBODIMENT

Referring to the above figures, a mechanism for adjusting a rotary angle of an LCD of the present invention includes a lower base 1, an upper base 2 and a positioning mechanism 3.

The lower base 1 is defined with a rotary center 11 at the top surface thereof. A sector recess 12 is defined in the top surface of the lower base with the rotary center being employed as the center of the sector. A portion of the inner edge of the sector recess is disposed with a rack 13 including a plurality of protruding teeth 131. The bottom surface of the sector recess is defined with at least two arcuate sliding grooves 14 (four arcuate sliding grooves are shown in the figures) which employ the rotary center 11 as the circular center thereof. The arcuate sliding grooves are in lateral symmetry which employs the rotary center 11 as the center thereof. An assembly hole 141 with a larger diameter is defined at an end of each arcuate sliding groove 14 for assembly or disassembly of a sliding post 23. A protruding support board 142 is formed at the periphery of each arcuate sliding groove 14.

In practice, the rotary center 11 is defined with a shaft hole 15 for pivotally connecting with a rotation shaft 22 of the upper base 2, thereby enabling the rotation of the upper base 2 to be more stable.

The upper base 2 is disposed with an LCD 21 at an upper portion thereof. The bottom surface of the upper base 2 is disposed with the rotation shaft 22 corresponding to the shaft hole 15 (rotary center 11) for pivotable connection of the rotation shaft 22 and the shaft hole 15. The bottom surface of the upper base are disposed with the sliding posts 23 corresponding to the position and number of the arcuate sliding grooves 14 for movably engaging with the arcuate sliding grooves 14. The sliding posts 23 slide in the arcuate sliding grooves 14 around the rotary center 11. An annular groove 231 is defined in each sliding post 23. In assembly, a flange 143 of the arcuate sliding groove 14 is aligned to and received in the annular groove 231. The positioning mechanism 3 is disposed at the bottom of the upper base 2 corresponding to the rack 13. The positioning mechanism includes a positioning spring 31 and a positioning push button 32 defined with a cavity 321. In practice, a frame 24 is disposed at the bottom surface of the upper base 2. The positioning push button 32 is received in the frame and is slidable in the frame. The positioning spring 31 is disposed between the frame 24 and the positioning push button 32.

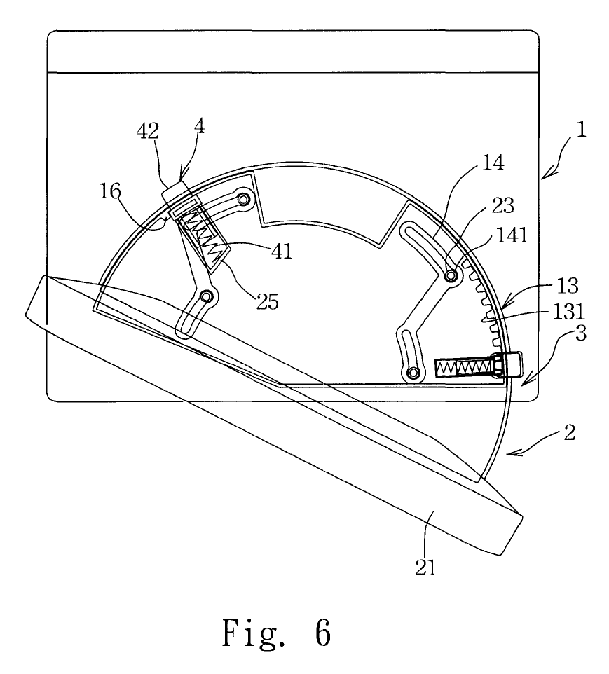

As shown in FIG. 6, in assembly, the sliding posts 23 of the upper base 2 are aligned to the assembly holes 141 of the arcuate sliding grooves 14 of the lower base 1 for enabling the flanges 143 of the arcuate sliding grooves 14 to insert into the annular grooves 231 of the sliding posts 23 and enabling the sliding posts 23 to slide and rotate in the arcuate sliding grooves 14 around the rotary center 11. The positioning mechanism 3 of the upper base 2 is aligned to the rack 13 of the lower base 1. The positioning spring 31 of the positioning mechanism 3 constantly urges the cavity 321 of the positioning push button 32 to mate with one of the protruding teeth 131 of the rack 13 thereby positioning the rotary angle of the upper base 2 and the LCD 21.

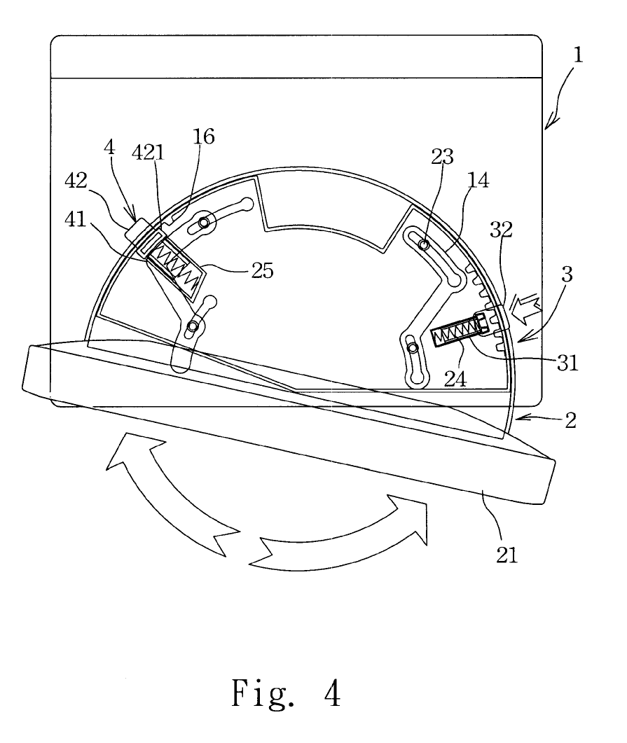

Referring to FIG. 4, when the positioning push button 32 is inwardly pushed, the cavity 321 of the positioning push button 32 is disengaged from the protruding tooth 131 thereby enabling the upper base 2 and the LCD 21 to rotate right and left to adjust the rotary angle. When the LCD 21 is adjusted to the desired rotary angle, the inward pushing force on the positioning mechanism 3 is released. As described above, due to the return resilience of the positioning spring 31, the cavity 321 of the positioning push button 32 engages with another protruding tooth 131 of the rack 13 thereby positioning the rotary angle of the LCD 21.

As shown in FIG. 6, when it is desired to detach the upper base 2, the upper base 2 is rotated to align the sliding posts 23 to the assembly holes 141 of the arcuate sliding grooves 14 of the lower base 1 such that the upper base 2 is detached.

In practice, the configuration positions of the rack 13 and the positioning mechanism 3 are interchangeable. That is, the rack 13 may be disposed at the bottom surface of the upper base 2, and the positioning mechanism 3 may be disposed at the top surface of the lower base 1. The function and effect of adjusting the rotary angle of the LCD 21 are similarly achieved.

In order to avoid undesired disengagement of the LCD 21 due to the sliding posts being rotated to the assembly holes 141 during the rotation, an inhibiting mechanism 4 is disposed at the adjusting mechanism of the present invention. In practice, a protrusion 16 is disposed at the inner edge of the sector recess 12 of the lower base 1. The inhibiting mechanism 4 is disposed at the bottom surface of the upper base 2 corresponding to the protrusion. The inhibiting mechanism 4 includes an inhibiting spring 41 and an inhibiting push button 42 having a block 421. In practice, a frame 25 is disposed at the bottom surface of the upper base 2. The inhibiting push button 42 is disposed in the frame 25 and is slidable in the frame. The inhibiting spring 41 is disposed between the frame 25 and the inhibiting push button 42.

The inhibiting spring 41 constantly urges the block 421 of the inhibiting push button 42 to outwardly move to abut against the protrusion 16 of the lower base 1 whereby the upper base 2 cannot be rotated to pass through the protrusion 16 and so the rotation scope of the upper base 2 and the LCD 21 is restricted.

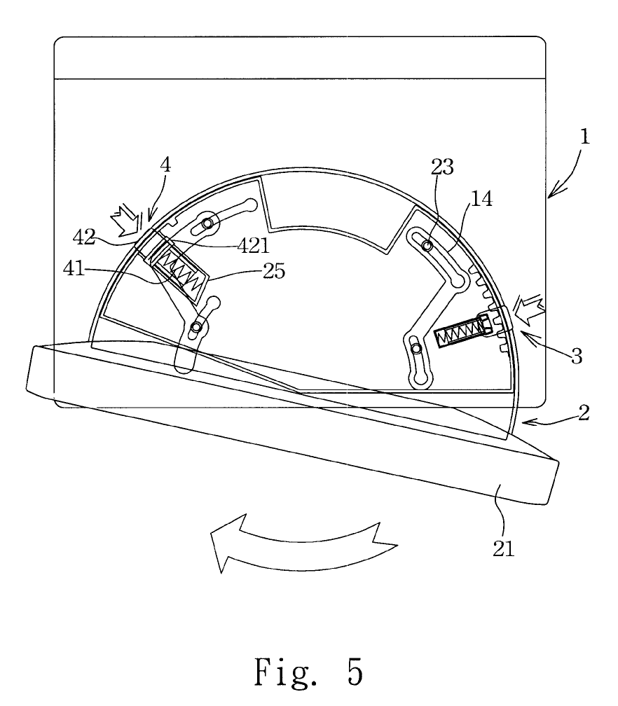

Referring to FIG. 5, when the inhibiting push button 42 of the inhibiting mechanism 4 is inwardly pushed, the block 421 of the push button is inwardly moved at the same time thereby releasing the block 421 from abutting against the protrusion 16, so releasing the restriction of the rotation scope of the upper base 2 and the LCD 21. That is, in normal operation, the rotation scope of the upper base 2 and the LCD 21 is restricted to prevent the undesired disengagement of the LCD. When it is desired to detach the LCD 21, the LCD 21 is allowed to rotate to enable the sliding posts 23 to align to the arcuate sliding grooves 14 of the lower base 1, thereby detaching the upper base and the LCD.

The configuration positions of the protrusion 16 and the inhibiting mechanism 4 are interchangeable; that is, the protrusion 16 may be disposed at the bottom surface of the upper base 2 and the inhibiting mechanism 4 may be disposed at the top surface of the lower base 1. The function and effect of restricting the rotary angle of LCD 21 are similarly achieved.

The preferred embodiments, aspects, and features of the invention have been described in detail. It will be apparent to those skilled in the art that numerous variations, modifications, and substitutions may be made without departing from the spirit of the invention as disclosed and further claimed below.

What is claimed is:

1. A mechanism for adjusting a rotary angle of an LCD, comprising:
a lower base defined with a rotary center at the top surface thereof, a sector recess being defined in the top surface of the lower base with the rotary center being employed as the center of the sector, a portion of the inner edge of the sector recess being disposed with a rack including a plurality of protruding teeth, the bottom surface of the sector recess being defined with at least two arcuate sliding grooves which employ the rotary center as the circular center thereof, the arcuate sliding grooves being in lateral symmetry;
an upper base disposed with an LCD at an upper portion thereof, the bottom surface of the upper base being disposed with sliding posts corresponding to the position and number of the arcuate sliding grooves for movably engaging with the arcuate sliding grooves, the sliding posts being slidable and rotatable in the arcuate sliding grooves around the rotary center; and
a positioning mechanism disposed at the bottom of the upper base corresponding to the rack, the positioning mechanism including a positioning spring and a positioning push button defined with a cavity, the positioning spring constantly urging the cavity of the positioning push button to mate with one of the protruding teeth of the rack thereby positioning the rotary angle of the upper base and the LCD, when the positioning push button is inwardly pushed, the cavity of the positioning push button being disengaged from the protruding tooth, thereby enabling the upper base and the LCD to rotate right and left.

2. The mechanism for adjusting a rotary angle of an LCD as claimed in claim 1, wherein the rotary center of the lower base is defined with a shaft hole, the bottom surface of the upper base is disposed with a rotation shaft corresponding to the shaft hole for pivotable connection of the rotation shaft and the shaft hole.

3. The mechanism for adjusting a rotary angle of an LCD as claimed in claim 1, wherein an assembly hole with a larger diameter is defined at each arcuate sliding groove.

4. The mechanism for adjusting a rotary angle of an LCD as claimed in claim 1, wherein a protruding support board is formed at the periphery of each arcuate sliding groove, an annular groove is defined in each sliding post, and a flange of each arcuate sliding groove is aligned to and received in the corresponding annular groove.

5. The mechanism for adjusting a rotary angle of an LCD as claimed in claim 1, wherein a frame is disposed at the bottom surface of the upper base, the positioning push button is slidable in the frame, and the positioning spring is disposed between the frame and the positioning push button.

6. The mechanism for adjusting a rotary angle of an LCD as claimed in claim 1, wherein the configuration positions of the rack and the positioning mechanism are interchangeable, that is, the rack is disposed at the bottom surface of the upper base, and the positioning mechanism is disposed at the top surface of the lower base.

7. The mechanism for adjusting a rotary angle of an LCD as claimed in claim 1, wherein a protrusion is disposed at the inner edge of the sector recess of the lower base, an inhibiting mechanism is disposed at the bottom surface of the upper base corresponding to the protrusion, the inhibiting mechanism includes an inhibiting spring and an inhibiting push button having a block, and the inhibiting spring constantly urges the block of the inhibiting push button to outwardly move to abut against the protrusion thereby restricting rotation scope of the upper base and the LCD, wherein when the inhibiting push button is inwardly pushed, the block is released from abutting against the protrusion, thereby releasing the restriction of the rotation scope of the upper base and the LCD.

8. The mechanism for adjusting a rotary angle of an LCD as claimed in claim 7, wherein a frame is disposed at the bottom surface of the upper base, the inhibiting push button is slidable in the frame, and the inhibiting spring is disposed between the frame and the inhibiting push button.

9. The mechanism for adjusting a rotary angle of an LCD as claimed in claim 7, wherein the configuration positions of the protrusion and the inhibiting mechanism are interchangeable, that is, the protrusion is disposed at the bottom surface of the upper base and the inhibiting mechanism is disposed at the top surface of the lower base.
